(19) United States
(12) Patent Application Publication
(10) Pub. No.: US 2003/0090834 A1
(43) Pub. Date: May 15, 2003

(54) High frequency thermally stable coil structure for magnetic recording heads utilizing a damascene process

(75) Inventors: Mallika Kamarajugadda, Edina, MN (US); Stephen Allen Jones, Lakeville, MN (US); Lori Grace Swanson, Savage, MN (US); Tien Quang Dam, Woodbury, MN (US); Ming Jiang, Bloomington, MN (US); Laura Christine Stearns, Minneapolis, MN (US); Lily Horng Youtt, Eagan, MN (US); Carolyn Marie Pitcher, Edina, MN (US)

Correspondence Address: MERCHANT & GOULD PC, P.O. BOX 2903, MINNEAPOLIS, MN, 55402-0903, US

(73) Assignee: Seagate Technology LLC.

(21) Appl. No.: 10/199,344

(22) Filed: Jul. 19, 2002

Related U.S. Application Data
(60) Provisional application No. 60/337,772, filed on Nov. 13, 2001.

(51) Int. Cl. G11B 5/17

(52) U.S. Cl. 360/123

(57) ABSTRACT

The invention offers a writer coil that includes an insulator layer having a top surface and a bottom surface, a dielectric layer positioned on the top surface of the insulator layer, and at least a first and a second coil structure having a pitch of less than about 2 μm. The invention also offers a method of fabricating a writer coil by depositing an insulator layer, depositing a dielectric layer on the insulator layer, and forming at least one coil space and at least one coil structure within the dielectric layer by a Damascene process.

This application claims priority to United States Provisional Application Serial No. 60/337,772 filed on Nov. 13, 2001, entitled “High Frequency Thermally Stable Coil Structure for Magnetic Recording Heads Utilizing a Damascene Process”.

### FIELD OF THE INVENTION

The invention relates generally to writer coils for magnetic recording heads and, in particular to a writer coil for a magnetic recording head for high frequency writers, that utilizes Damascene processing in its fabrication.

### BACKGROUND OF THE INVENTION

Thin film magnetic read/write heads are used to read information from and write information to magnetic tapes or discs. A writer includes a top pole, a bottom pole, and a gap between the two that writes the information to the storage medium. In order to provide a maximum density of information on the storage medium, the track widths of the media must become increasingly smaller.

The density of information on a storage medium is usually measured by areal density. The areal density of rotating disc drives can be found by multiplying the number of bits along a track by the number of tracks available per storage medium. Storage medium currently in use have areal densities greater than 30 Gb/in². Research efforts are currently focusing on manufacturing storage media with areal densities greater than 80 Gb/in². In order to utilize storage media with such advanced areal densities, the size of the writers must be decreased.

Fabrication of currently utilized writer coils involves deposition of a seed layer, creation of coil patterns using photolithography, plating copper into the coil patterns, removal of the seed layer in the field by ion milling, filling in the spaces between the coils with photoresist, and curing the photoresist for two hours.

The minimum size and reliability of coils produced by such methods is limited in part by the photolithography step. There are a number of limitations inherent in photolithography. Photolithography techniques utilize light, and therefore the minimum dimensions that photolithography can attain are limited by the wavelength of light utilized to print. The width of the line printed becomes the width of the coil. The smallest wavelength of light currently used is greater than 0.5 μm, therefore, a writer coil with a width of 0.5 μm or smaller cannot be obtained. This generally translates to a pitch (which is the distance from the center of one coil to the center of another) of not less than 1.5 μm, and generally about 2.0 μm.

The size of the coils produced by prior art methods are also limited by removal of the seed layer. Removal of the seed layer becomes difficult with tall and tightly pitched coils. Therefore, the pitch of the coils must remain high. Redeposition during the seed layer removal process can also cause corrosion.

Cured photoresist as an insulator between the copper coils also creates problems. Cured photoresist has very poor thermal properties and has a large coefficient of thermal expansion. Because of its poor thermal properties, photoresist cannot stand up to the high temperatures generated by joule heating. Because the photoresist functions as an insulator, this breakdown leads to shorting between the coils. Large differences in the coefficient of thermal expansion of the photoresist and the metallic layer can also cause the pole tips/shields to protrude past the air bearing surface at higher operating temperatures which decreases the head-media spacing.

As explained above, even if writer coils with smaller dimensions could be made, the use of the current technology would leave them with a number of problems. Furthermore, as the size decreases, the power dissipated within the writer structure does not decrease accordingly. These power losses are actually predicted to increase due to increasing coil resistance in the core region, and decreasing writer pole widths. Such power losses create even more problems in the reliability of the writers.

As evidenced by the fabrication constraints and the numerous problems associated therewith, currently utilized writer coils cannot be made smaller and if they could, reliability problems would remain. Therefore, there remains a need for smaller writer coils that are reliable.

### SUMMARY OF THE INVENTION

The invention offers a writer coil that includes an insulator layer having a top surface and a bottom surface, a dielectric layer positioned on the top surface of the insulator layer, and at least two coil structures having a pitch of less than about 2 μm, wherein the dielectric layer functions to insulate one coil structure from other coil structures.

Writer coils of the invention can be used for magnetic recording head structures for high frequency writing. Because coils of the invention have a tight pitch the core length can be reduced as needed for high data rate writing by the recording head. In addition, the flat topography of the writer coils (produced by the planarization step) enables better control of the critical dimensions for the top pole. Replacing the cured photoresist (PR) insulator with a dielectric layer was also found to improve the heat dissipation of the coils and also help in reducing the thermal pole tip recession. Furthermore, the copper deposited for the coils has a low resistivity, which leads to high current density and higher magnetic flux from the writer, which ultimately leads to increased head reliability. Writer coils of the invention were shown to substantially improve the writer reliability by reducing the risk of latent defects from large process variations and are extendable to coils with higher aspect ratios (height to width ratio), tighter (smaller) pitch and short yokes.

The invention also offers a method of fabricating a writer coil by depositing an insulator layer, depositing a dielectric layer on the insulator layer, and forming at least one coil space and at least one coil structure within the dielectric layer by a Damascene process.

One embodiment of a method of the invention involves deposition of a dielectric layer, preferably made of silicon dioxide, over the shared pole of the magnetic recording head. Then, the trenches are patterned in the dielectric film utilizing a Reactive Ion Etch (RIE) technique. The trenches are then filled with a barrier layer, a seed layer, and a coil layer followed by Chemical Mechanism Planarization (CMP) of the excess coil layer to yield a planar structure. Tightly pitched coils with ARs of up to 8:1 can be produced by this method. This invention also describes successful integration of the Damascene coil process into the recording head build

### BRIEF DESCRIPTION OF THE DRAWINGS

FIG. 1 illustrates a cross-sectional view of a prior art magnetic recording head.

FIG. 2 illustrates a cross-sectional view of a writer coil in accordance with one embodiment of the invention.

FIG. 3 illustrates the writer coil of FIG. 2 with two of the coil structures removed.

FIGS. 4 through 11 illustrate a writer coil structure in accordance with the invention at succeeding points in the fabrication thereof.

FIG. 12 illustrates a cross-sectional view of a writer coil structure in accordance with one embodiment of the invention integrated into a magnetic recording head.

FIG. 13 illustrates Focus Ion Beam (FIB) images of a writer coil structure with an aspect ratio of 4:1 in accordance with the invention.

FIG. 14 illustrates Focus Ion Beam (FIB) images of a writer coil structure with an aspect ratio of 8:1 in accordance with the invention.

FIG. 15 illustrates a Focus Ion Beam (FIB) image of the writer coil of FIG. 14 after planarization with a chemical mechanical planarization (CMP) process.

FIG. 16 depicts a bar graph of the breakdown current density distribution between a writer coil in accordance with the invention and a standard writer coil.

FIG. 17 depicts the breakdown characteristics between the a writer coil in accordance with the invention and a standard writer coil.

### DETAILED DESCRIPTION OF THE PREFERRED EMBODIMENT

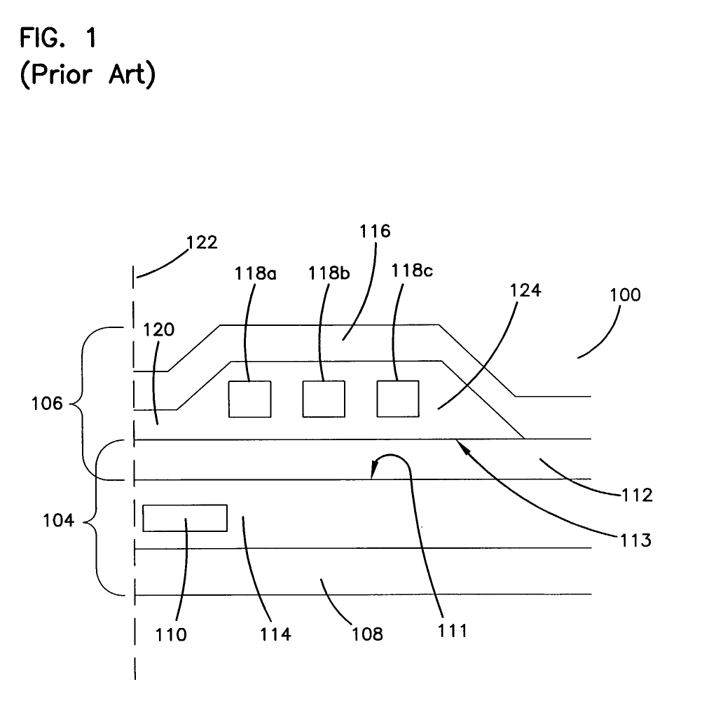

FIG. 1 illustrates a cross-sectional view of a magnetic recording head 100 of the prior art. A magnetic recording head 100 includes a reader portion 104 and a writer portion 106.

The reader portion 104 includes a bottom shield 108, a reader 110, a shared pole 112, and a reader gap 114. The reader 110 is positioned between the shared pole 112 and the bottom pole 108. The reader 110 is also adjacent to an air bearing surface 122 of the magnetic recording head 100. The writer portion 106 includes the shared pole 112, a top pole 116, a writer coil 118a, b, and c, and a writer gap 120. The writer gap 120 is adjacent the air bearing surface 122 of the magnetic recording head 100. The shared pole 112 acts both as a top pole for the reader portion 104 and a bottom pole for the writer portion 106. The shared pole 112 can alternatively include a shared pole extension (not pictured). The shared pole extension, if a part of the shared pole 112 is positioned on top of the remainder of the shared pole 112 and functions to increase the flux of the shared pole 112. The shared pole 112 has a bottom surface 111 that is directly adjacent to and in physical contact with the remainder of the reader portion 104. The shared pole 112 also has a top surface 113 on which the writer coil 121 is positioned.

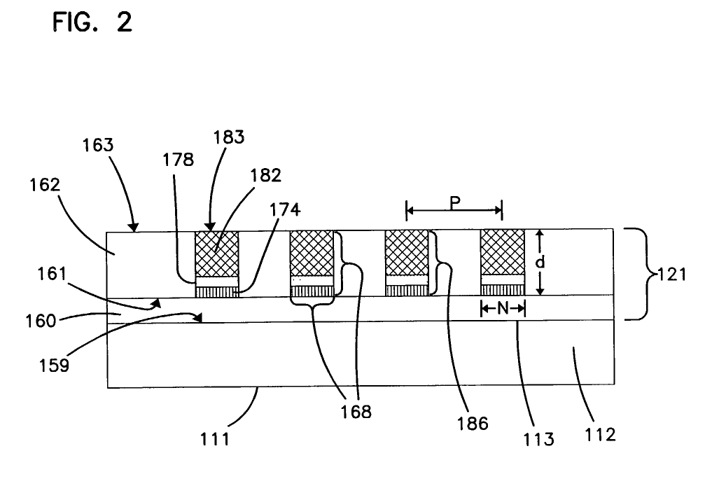

FIG. 2 illustrates a cross-sectional view of a writer coil 121 in accordance with the invention. When integrated within a magnetic recording head 100, the writer coil 121 is positioned on the shared pole 112. The writer coil 121 includes an insulator layer 160, a dielectric layer 162, and at least a first and a second coil structure 186.

Positioned directly on the top surface 113 of the shared pole 112 is the insulator layer 160. The insulator layer 160 functions to insulate the rest of the writer coil 121 from the remainder of the magnetic recording head 100. The insulator layer 160 also functions in the fabrication of a device of the invention as a stop-etch layer. The insulator layer 160 has a bottom surface 159 that is directly adjacent to and in physical contact with the top surface 113 of the shared pole 112. The insulator layer 160 also has a top surface 161 that is directly across from the bottom surface 159. The insulator layer 160 can be made of any substance that can effectively insulate the rest of the writer coil 121 from the remainder of the magnetic recording head 100. Preferably, the material of the insulator layer 160 is one which has a coefficient of thermal expansion that is similar to the materials used to make the other components of the writer coil 121 and the remainder of the magnetic recording head 100. Examples of materials for the insulator layer 160 include but are not limited to aluminum oxide (Al₂O₃), aluminum nitride (AlN), silicon dioxide (SiO₂), silicon nitride (Si₃N₄), or combinations thereof. Preferably, insulator layer 160 comprises aluminum oxide (Al₂O₃). The insulator layer 160 is preferably from about 1500 to about 3500 Å thick. Most preferably, insulator layer 160 is about 3000 Å thick.

The writer coil 121 also includes the dielectric layer 162. The dielectric layer 162 functions to insulate the coil structures 186 from one another. In a prior art writer coil, the insulation of the coil structures from one another is accomplished by photoresist (see 124 in FIG. 1). A writer coil 121 formed according to a preferred embodiment of the invention offers an advantage because dielectric materials, which are better insulators than photoresist, are used. In a preferred embodiment of the invention, the dielectric layer 162 covers the entirety of the shared pole extension (not shown) of the shared pole 112. The dielectric layer 162 has a bottom surface 165 that is directly adjacent to the top surface 161 of the insulator layer 160. The dielectric layer 162 also has a top surface 163 that is directly across fiom the bottom surface 165 of the dielectric layer 162.

Preferably, the material of the dielectric layer 162 has a coefficient of thermal expansion that is similar to the other components of the writer coil 121 and the remainder of the magnetic recording head 100. Examples of materials for the dielectric layer 162 include but are not limited to silicon oxides (SiOₓ), silicon oxide nitrides (SiOₓN_{y}), silicon nitrides (SiₓN_{y}), or combinations thereof. Preferably, the dielectric layer 162 is made of silicon dioxide (SiO₂). The thickness of the dielectric layer 162 is dependent in part on the aspect ratio (AR) of the coil structures 186. In most instances, the dielectric layer 162 is preferably from about 1.5 μm (15000 Å) to about 2.5 μm (25000 Å) thick. Most preferably, the dielectric layer 162 is about 2 μm (20000 Å) or 4 μm (40000 Å) thick.

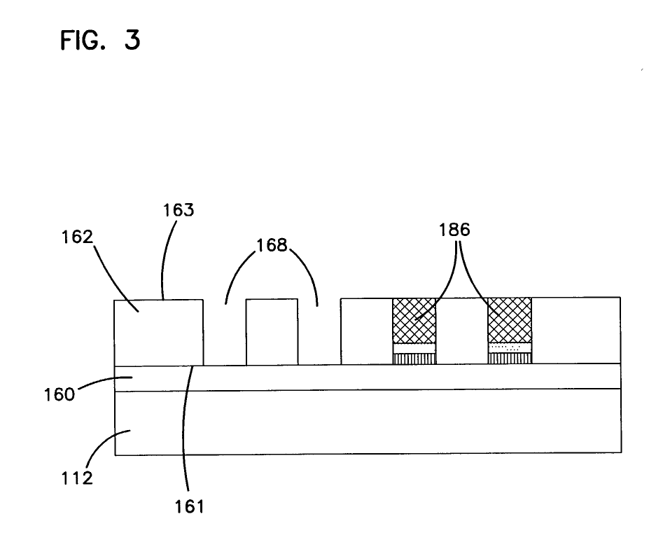

The dielectric layer 162 does not cover the entire surface of the insulator layer 160. FIG. 3 depicts a magnetic recording head 100 of the invention with two of the coil structures 186 removed, leaving two coil spaces 168 empty. The coil spaces 168 are defined by the plane of the top surface 163 of the dielectric layer 162 and the top surface 161 of the insulator layer 160. In a preferred embodiment, the coil structures 186 are deposited and planarized to fit within the coil spaces 168. In writer coils 121 of the invention, all the coil spaces 168 contain coil structures 186.

If the writer coil 121 is looked at from above, the coil structures 186 define a single continuous formation, or continuous coil. The number of coil spaces 168 and coil structures 186 is dictated by the number of times that the continuous coil is looped, or how many turns there are. Generally, there are from four (4) to six (6) turns of the continuous coil resulting in four to six coil spaces 168 and coil structures 186. Preferably there are six turns that result in six coil spaces 168 and six corresponding coil structures 186.

The coil spaces 168 and the corresponding coil structures 186 can be defined both by their aspect ratio (AR) and their pitch. Referring again to FIG. 2, the AR of a coil space 168 is defined as the depth of the coil space 168, d, in FIG. 2 in relation to the width of the coil space 168, w, in FIG. 2. Devices of the invention preferably have an AR of 4:1 or greater. An example of a coil space 168 that has an AR of 4:1 is one with a depth of 2 μm, and a width of 0.5 μm. Devices of the invention more preferably have an AR of 8:1 or greater. An example of a coil space 168 that has an AR of 8:1 is one with a depth of 4 μm, and a width of 0.5 μm.

The pitch is another characteristic by which the coil spaces 168 and the coil structures 186 can be defined. The pitch is defined as the distance from the center of one coil space 168 or coil structure 186 to the next adjacent coil space 168 or coil structure 186. This distance is depicted as p in FIG. 2. Devices of the invention have a pitch less than 2 μm. Devices of the invention preferably have a pitch of from about 1 μm to 2 μm. More preferably, devices of the invention have a pitch of about 1.5 μm. The coil spaces 168 also can, but need not, have straight side walls. Preferably, the coil spaces 168 have straight walls. Straight walls minimize the possibility of a coil structure 186 shorting out by contacting another coil structure 186. Lessening the possibility of shorting provides a writer coil 121 and a magnetic recording head 100 that are more reliable.

The coil spaces 168 and the corresponding coil structures 186 are formed through a process referred to as a Damascene process. A Damascene process is one in which a space (here a coil space 168) is formed by etching, then a material (here the materials that make up a coil structure 186) is deposited therein, and finally the excess material is removed by polishing. The use of this process allows the coil spaces 168 and the coil structures 186 to have a higher AR and a lower pitch than writer coils of the prior art, in addition to straighter walls.

A coil structure 186 in accordance with the invention include a barrier portion 174, a seed portion 178 and a coil 182. The barrier portion 174 has a two fold function. The barrier portion 174 functions to aid adhesion of the material of the coil 182 to the top surface 161 of the insulator layer 160. The barrier portion 174 also functions as a diffusion layer which prevents diffusion of the materials of the coil 182 into the dielectric layer 162. The barrier portion 174 is located within the coil space 168. The barrier portion 174 is directly adjacent to and in contact with the top surface 161 of the insulator layer 160.

The coil structures 186 generally have a depth that is equal to the thickness of the dielectric layer 162. Therefore, the depth of coil structures 186 as well as the thickness of the dielectric layer 162 are dependent in part on the desired AR of the coil structures 186. Generally however, the coil structures have a depth of about 1.5 to about 4.5 μm. Preferably, the coil structures 186 have a depth of either about 2.0 μm or about 4.0 μm, depending on the desired AR.

The barrier portion 174 completely covers the bottom of the coil space 168 and have a depth of from about 200 to about 300 Å. Preferably, the barrier portion 174 has a depth of about 250 Å. The barrier portion 174 can be made of any material that can aid adhesion of the material of the coil 182 to the insulator layer 160 and prevent diffusion of the material of the coil 182 into the insulator layer 160. Preferably, the barrier portion 174 is made of a material that has a thermal coefficient of expansion that is similar to the other components of the writer portion 121 and the magnetic recording head 100. Examples of materials that can be utilized for barrier portion 174 include but are not limited to tantalum (Ta), tantalum nitride (TaN), titanium (Ti), titanium nitride (TiN), or combinations thereof. Preferably, the barrier portion 174 is made of tantalum, tantalum nitride, or combinations thereof.

The seed portion 178 functions to promote nucleation of the material that makes up the coil 182. The seed portion 178 is also located within the coil space 168, and is positioned on top of and in contact with the barrier portion 174.

The seed portion 178 completely covers the barrier portion 174 and has a depth of from about 400 to about 600 Å. Preferably, the seed portion 178 has a depth of about 500 Å. The seed portion 178 is made of the same material as the coil 182.

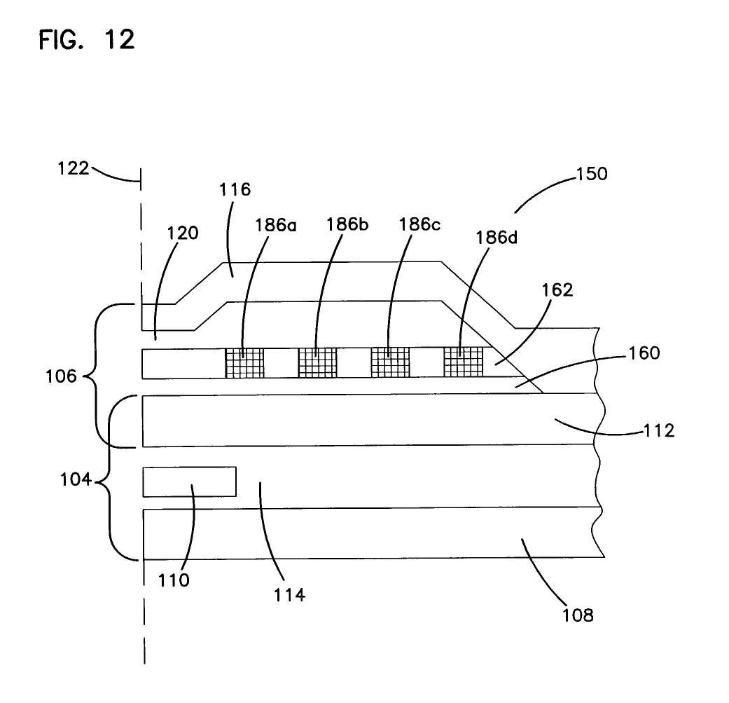

The coil structure 186 also contains the coil 182. The coil 182 functions to write data to a magnetic storage medium. To write data, an electrical current is caused to flow through the continuous coil created by the coil structures 186. This electrical current induces a magnetic field across the writer gap 120 (a writer gap 120 in a magnetic recording head 100 in accordance with the invention can be seen in FIG. 12). When the polarity of the electrical current is reversed, the polarity of the data written to the storage medium is also reversed.

The coil 182 completely covers the seed portion 178 and fills the entirety of the coil space 186. The coil 182 has a top surface 183. The top surface 183 of the coil 182 is generally coplanar with the top surface 163 of the dielectric layer 162. The coil 182 therefore has a depth of about 1000 Å to about 3500 Å. Preferably the coil 182 has a depth such that the entire coil structure 186 has a depth of either about 20000 Å (2 μm) or about 40000 Å (4 μm). The coil 182 can be made of any material that can induce a magnetic field across the writer gap 120 when an electrical current is flowed through it, generally such materials are described as highly electrically conducting metals including, but not limited to, copper. Preferably, the coil 182 is made of copper, in this embodiment, the seed portion 178 is also made of copper.

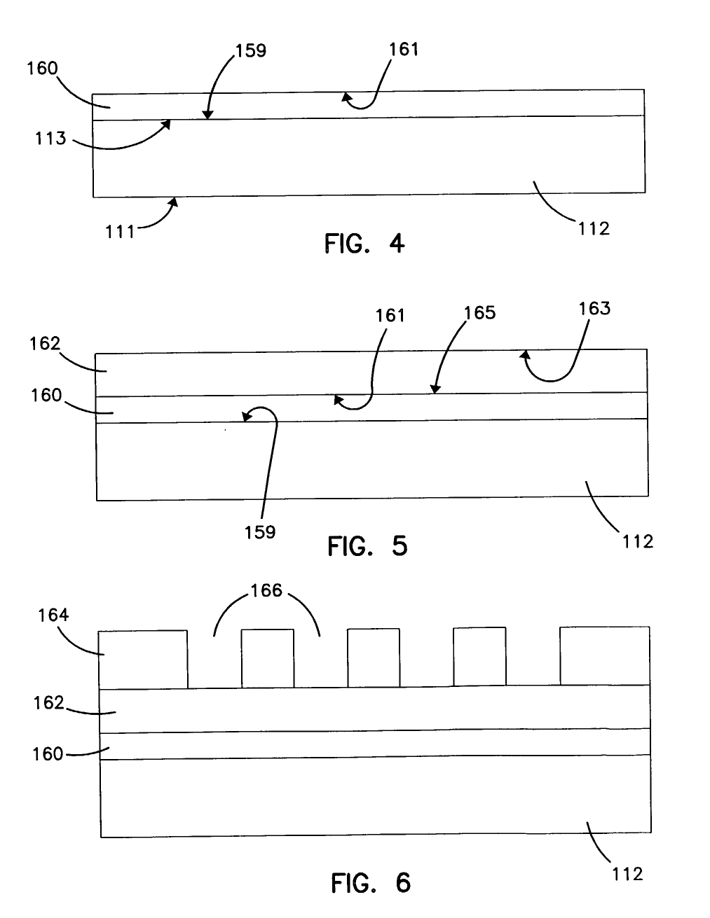

An example of a method of fabricating a device of the invention is illustrated in FIGS. 4 through 11, and will be discussed with reference thereto below.

A device according to a preferred embodiment of the invention can be fabricated and integrated into magnetic recording heads in any way commonly known and used by those of ordinary skill in the art. A preferred way of integrating a writer coil 121 into a magnetic recording head 100 is to integrate the fabrication thereof into the wafer build stage of the magnetic recording head 100. Preferably, the fabrication of a writer coil 121 in accordance with the invention is integrated into a magnetic recording head 100 at the wafer build stage where the shared pole extension is plated on the planar-shared pole (collectively represented by the shared pole 112 in the figures). The following method of fabricating a writer coil 121 is one example of a method that can be integrated into fabrication of a magnetic recording head 100 in this fashion.

A writer coil 121 in accordance with the invention after the first step in a fabrication method is illustrated in FIG. 4. The first step is to deposit an insulator layer 160 onto the top surface 113 of the shared pole 112 so that the bottom surface 159 of the insulator layer 160 is in physical contact with the top surface 113 of the shared pole 112. The insulator layer 160 can be deposited by any method known to those of ordinary skill in the art including but not limited to sputtering. Deposition of the insulator layer 160 by sputtering would be well within the skill level of one of ordinary skill in the art.

A writer coil 121 in accordance with the invention after the next step, formation of a dielectric layer 162 is depicted in FIG. 5. The dielectric layer 162 is deposited on the top surface 161 of the insulator layer 160 so that the bottom surface 165 of the dielectric layer 162 is in physical contact with the top surface 161 of the insulator layer 160. The dielectric layer 162 can be deposited by any method known to those of ordinary skill in the art, including but not limited to chemical vapor deposition (CVD), physical vapor deposition (PVD), or thermal oxidation. Preferably, the dielectric layer 162 is deposited by CVD using silane, nitrous oxide, and nitrogen based chemistry at 180° C. In one preferred method, the material of the insulator layer 160 is deposited thicker than the final desired thickness of the insulator layer 160, and the material is then processed to result in the desired thickness of the insulator layer 160.

The steps of the method illustrated in and discussed with respect to FIGS. 6 through 11 is an example of a Damascene process.

A writer coil 121 in accordance with the invention after the next step, formation of a photoresist layer 164 and spaces 166 is illustrated in FIG. 6. Various methods for formation of the photoresist layer 164 and the spaces 166 are well known to those of ordinary skill in the art, and any such method can be utilized. A general description of such a process is given below.

First, the dielectric layer 162 is coated with a thin layer of photoresist. Photoresist is a polymeric mixture that can be either positive or negative. The photoresist is irradiated through a mask, which in the case of positive photoresist is an exact copy of the desired photoresist layer 164 and the spaces 166. Irradiation with light in the near ultraviolet region of the spectrum modifies the chemical properties of the polymeric mixture and in the case of “positive” photoresist, makes it more soluble to certain developers. The next step then removes the exposed photoresist polymer through use of a suitable developer to give the resulting photoresist layer 164 and the spaces 166.

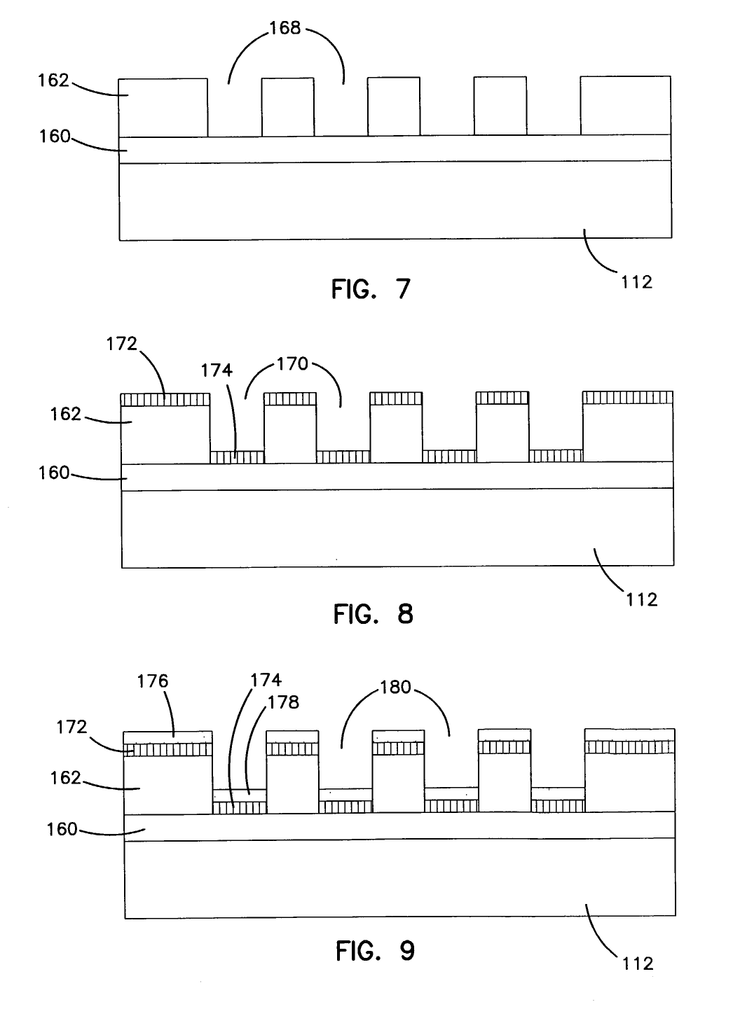

A device after the next step in a method of fabrication, etching of a coil space 168 is illustrated in FIG. 7. After the photoresist layer 164 and the spaces 166 have been formed, the structure thereof is used to form a coil space 168 through the use of etching. The dielectric layer 162 is etched below spaces 166 to form the coil spaces 168. Any method of etching known to and commonly used by those of ordinary skill in the art can be utilized. Examples of methods include, but are not limited to, reactive ion etching (RIE). Preferably, the etching is accomplished through use of RIE using an inductively coupled plasma (ICP) process with fluorine based chemistry. Preferably, the insulator layer 160 functions as an etch stop layer that defines how far the etching process progresses into the device.

After the coil spaces 168 have been formed, a device after the next step in the fabrication, formation of a barrier layer 172 and a barrier portion 174, is illustrated in FIG. 8. The barrier layer 172 and the barrier portion 174 are generally deposited as one continuous sheet over the entire surface of the dielectric layer 162. The barrier layer 172 and the barrier portion 174 can be deposited by any method known to those of ordinary skill in the art, including but not limited to sputtering. Deposition of the barrier layer 172 and the barrier portion 174 by sputtering would be well within the skill level of one of ordinary skill in the art.

A device after the next step in a method of fabrication, formation of a seed layer 176 and a seed portion 178, is depicted in FIG. 9. The seed layer 176 and the seed portion 178 are generally deposited as one continuous sheet over the entire surface of the barrier layer 172 and the barrier portion 174. The seed layer 176 and the seed portion 178 can be deposited by any method known to those of ordinary skill in the art, including but not limited to sputtering. Deposition of the seed layer 176 and the seed portion 178 by sputtering would be well within the skill level of one of ordinary skill in the art.

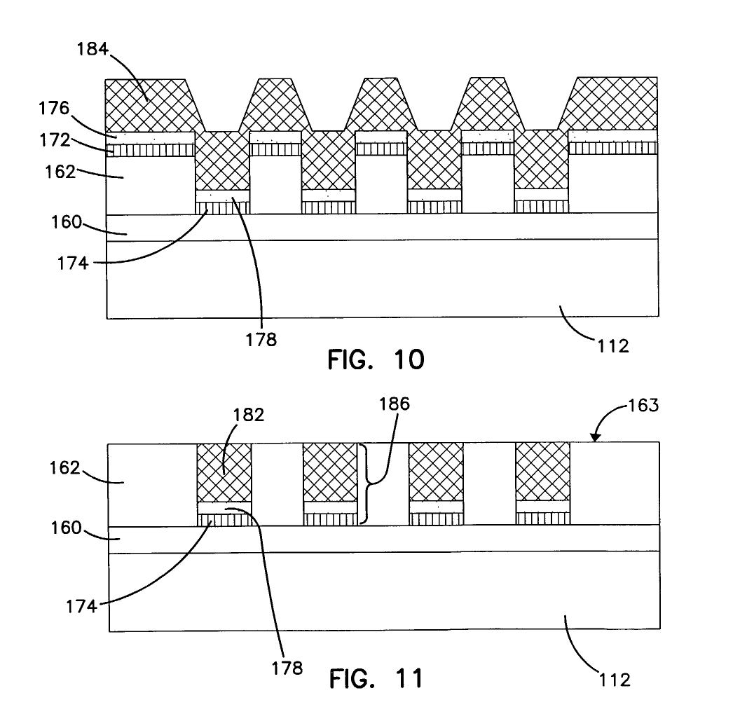

A device after the next step in a method of fabrication, formation of a coil layer 184, is illustrated in FIG. 10. The coil layer 184 is formed through deposition of a constant thickness (generally about 2 to 3 μm) layer across the surface of the seed layer 176 and the seed portion 178. However, because of the presence of the partially filled coil spaces 168, the surface of the coil layer 184 will have a variable height. The coil layer 184 can be deposited by any method known to those of ordinary skill in the art, including but not limited to chemical vapor deposition (CVD). Deposition of the coil layer 184 by CVD would be well within the skill level of one of ordinary skill in the art.

A device after the next step, planarization, is depicted in FIG. 11. This step functions to planarize the top surface 163 of the writer coil 121 and remove the excess coil layer 184, the excess seed layer 174, the excess barrier layer 172 and alternatively a portion of the dielectric layer 162. Any method known to those of ordinary skill in the art can be utilized to remove these layers, including but not limited to chemical mechanical planarization (CMP), or other polishing methods.

Preferably, CMP is utilized to remove the layers in either one or two steps. More preferably, the CMP process that is utilized has two distinct steps; first the coil layer 184 is subjected to CMP that stops at the barrier layer 184, then the barrier layer 184 is removed by CMP that stops at the dielectric layer 162. After the planarization step, the coil structures 186 are fully defined and include the coil 182, the seed portion 178, and the barrier portion 174.

The method for fabricating a writer coil 121 can then be further integrated into known methods for manufacturing a magnetic recording head 100. Incorporating a writer coil 121 into a fabrication method for a magnetic recording head 100 leads to fabrication of a magnetic recording head 100, an example of which is depicted in FIG. 12. In one embodiment, the subsequent steps in the fabrication of the recording head include deposition of frosting seed layer, frosting backfill, write gap Alumina, top pole plating, studs, over-coat deposition and pads which are not part of the present invention and thus need not be described in further detail.

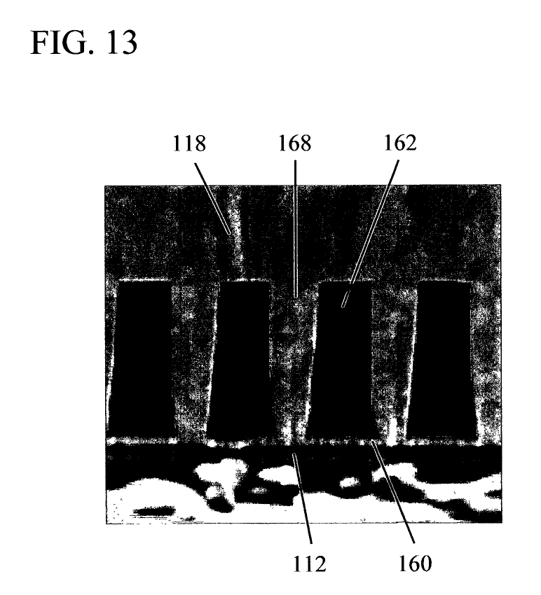

FIG. 13 shows a Focus Ion Beam (FIB) image of a cross-section of a writer coil 121 made in accordance with the invention that has coil spaces 168 with an AR of 4:1. The writer coil 121 seen in FIG. 13 has not yet been subjected to planarization, therefore the coil layer 184 is present, and the coil structures 186 have not yet been defined. FIG. 13 also shows the relatively straight walls of the coil spaces 168.

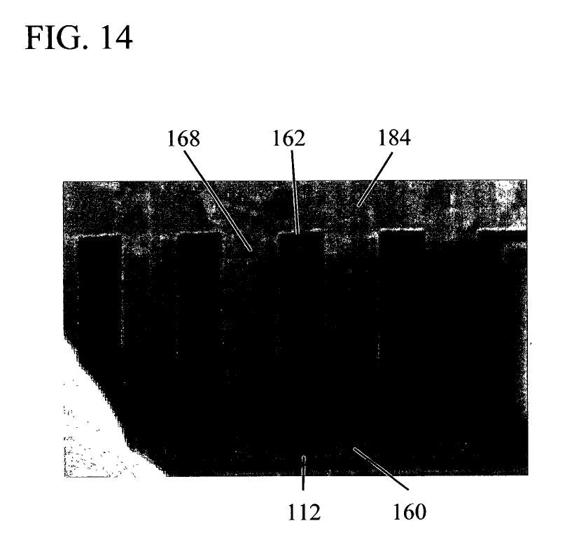

FIG. 14 shows a FIB image of a cross-section of a writer coil 121 in accordance with the invention that has coil spaces 168 with an AR of 8:1. This writer coil 121 is at the same stage of processing that the writer coil 121 of FIG. 13 was and therefore has the same features.

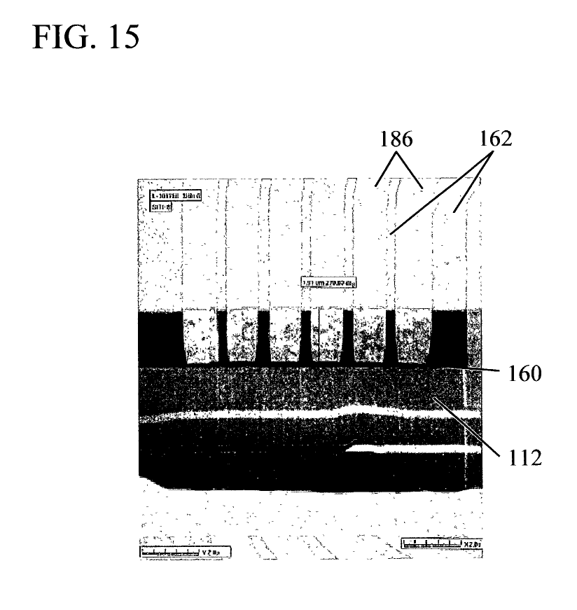

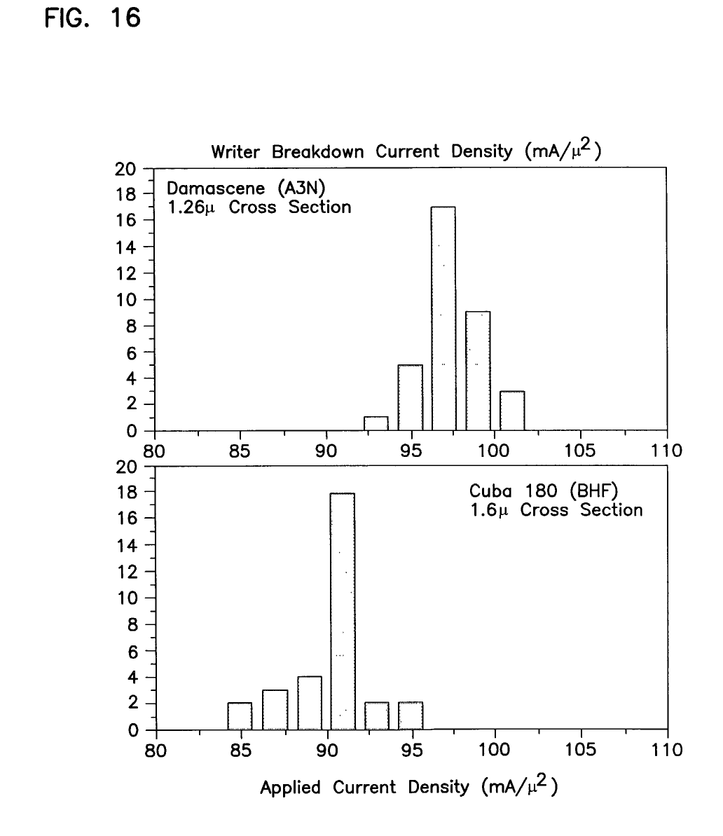

FIG. 15 shows a FIB image of a cross-section of the writer coil 121 of FIG. 14 after the planarization step. As can be seen in FIG. 15, the coil layer 184 is no longer present, and the coil structures 186 have been fully defined.

Magnetic recording heads 100 including a writer coil 121 (with 6 coil turns) according to the invention, and magnetic recording heads that included prior art writer coils (with 6 coil turns) were subjected to AC life stress testing by methods well known to those of ordinary skill in the art with a stress current of 160 mA p-p, a stress frequency of 100 Hz. Table 1 below shows the results of the AC life stress testing.

TABLE 1

| | Number of failures after | Percent |
|---|---|---|
| | 210 hours | Failure |
| Cuda 180 | 20 failures/61 tested | 33% failure |
| (prior art writer) | | |
| GT5 | 4 failures/19 tested | 21% failure |
| (prior art writer) | | |
| Writer coil of | 0 failures/56 tested | 0% |
| the invention | | |

After 475 hours of stress life tests no failures were observed in magnetic recording heads 100 that included writer coils 121 in accordance with the invention Magnetic recording heads including writer coils of the prior art had ˜33% and 21% failure after only 210 hours of testing.

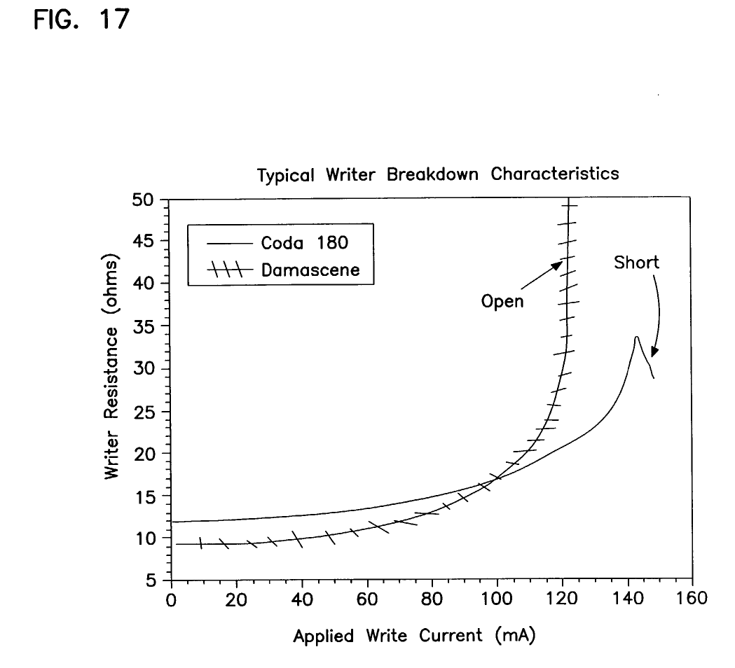

The breakdown current density distribution of a magnetic recording head 100 including a writer coil 121 in accordance with the invention and a magnetic recording head having a prior art writer coil was also compared. FIG. 16 shows the breakdown current density distribution comparison between the two heads. Since the copper, preferably deposited by CVD, in writer coils 121 in accordance with the invention has a lower resistivity than the plated copper of the prior art writer coils, initial non-joule heated resistance of the writer coils 121 of the invention was lower. Therefore, the breakdown current density and the power density were higher than the prior art writer coil. Further, the distributions were much tighter for the writer coil 121 of the invention when compared to the prior art writer coil.

The breakdown mode of the writer coil 121 in accordance with the invention was also compared to that of a prior art writer coil The breakdown mode of a writer coil 121 in accordance with the invention was open, in contrast to the prior art writer coil, as seen in FIG. 17. It can be inferred from this figure that the breakdown in the prior art writer coil is representative of large scale shorting caused by the breakdown of the photoresist at high temperatures which results in shorting of the writer coils. In contrast, the dielectric layer 162 used as a coil insulator in a writer coil 121 in accordance with the invention can withstand higher temperatures. Therefore, the failure mode is open, indicative of an electro-migration like phenomenon associated with copper. Thus it can be seen that a writer coil 121 of the invention results in much improved coil burn out reliability compared to prior art writer coils. Further, a method of manufacturing writer coils in accordance with the invention creates a more reliable writer coil by reducing the risk of latent defects or weaknesses from large process variations.

The above specification, examples and data provide a complete description of the manufacture and use of the composition of the invention. Since many embodiments of the invention can be made without departing from the spirit and scope of the invention, the invention resides in the claims hereinafter appended.

We claim:

1. A writer coil comprising:
a) an insulator layer comprising a top surface and a bottom surface;
b) a dielectric layer positioned on said top surface of said insulator layer; and
c) at least a first and second coil structure, wherein said coil structures have a pitch of less than about 2 μm,
wherein said dielectric layer insulates said first coil structure from said second coil structure.

2. The writer coil of claim 1 wherein said insulator layer is chosen from the group consisting of aluminum oxide, aluminum nitride, silicon dioxide, silicon nitride, and combinations thereof.

3. The writer coil of claim 1, wherein said insulator layer has a thickness between about 1500 and about 3500 Å.

4. The writer coil of claim 1, wherein said dielectric layer is chosen from the group consisting of silicon oxides, silicon oxide nitrides, silicon nitrides, and combinations thereof.

5. The writer coil of claim 4, wherein said dielectric layer is silicon dioxide.

6. The writer coil of claim 1, wherein said dielectric layer is between about 15000 and about 45000 Å thick.

7. The writer coil of claim 1, wherein said coil structure was formed by a Damascene process.

8. The writer coil of claim 1, wherein said coil structure comprises a barrier portion, a seed portion, and a coil.

9. The writer coil of claim 8, wherein said barrier portion is chosen from the group consisting of tantalum, tantalum nitride, titanium, titanium nitride, or combinations thereof.

10. The writer coil of claim 8, wherein said barrier portion is between about 200 and about 300 Å thick.

11. The writer coil of claim 8, wherein said seed portion comprises copper.

12. The writer coil of claim 8, wherein said seed layer is between about 400 and about 600 Å thick.

13. The writer coil of claim 8, wherein said coil comprises copper.

14. The writer coil of claim 8, wherein said coil is between about 10000 and about 35000 Å thick.

15. The writer coil of claim 1, wherein said coil structures have an aspect ratio of greater than or equal to 4:1.

16. The writer coil of claim 1, wherein said coil structure has a pitch of about 1.5 μm.

17. A method of fabricating a writer coil comprising the steps of:
a) depositing an insulator layer;
b) depositing a dielectric layer on said insulator layer; and
c) forming at least one coil space and at least one coil structure within said dielectric layer by a Damascene process.

18. The method of claim 17, wherein said coil space is formed by reactive ion etching using a phototresist pattern.

19. The method of claim 18, further comprising depositing a barrier layer and a barrier portion.

20. The method of claim 19, further comprising depositing a seed layer and a seed portion.

21. The method of claim 20, further comprising depositing a coil layer on top of said seed portion.

22. The method of claim 21, further comprising planarizing said layers to form a coil structure.

23. The method of claim 22, wherein said planarizing is accomplished by chemical mechanical planarization.

24. The method of claim 23, wherein said chemical mechanical planarization is accomplished in a first and a second step.

25. The method of claim 24, wherein said first step removes excess coil layer and seed layer.

26. The method of claim 25, wherein said second step removes said barrier layer.

27. The method of claim 17, wherein said insulator layer is deposited on a shared pole of a magnetic recording head.

28. The method of claim 17, further comprising the step of fabricating the remainder portion of a magnetic recording head.

29. The method of claim 28, wherein said step of fabricating the remainder portion of a magnetic recording head comprises at least one of the following:
deposition of a frosting seed layer, frosting backfill, formation of writer gap Alumina, top pole plating, formation of studs, over-coat deposition, formation of pads, or combinations thereof.

30. A writer coil comprising:
a) an insulator layer comprising a top surface and a bottom surface;
a) at least a first and second coil structure, wherein said coil structures have a pitch of less than about 2 μm; and
c) a dielectric means for insulating said first coil structure from said second coil structure.
